(19) United States
(12) Patent Application Publication
(10) Pub. No.: US 2024/0070516 A1
(43) Pub. Date: Feb. 29, 2024

(54) MACHINE LEARNING CONTEXT BASED CONFIDENCE CALIBRATION

(71) Applicant: ADOBE INC., SAN JOSE, CA (US)

(72) Inventors: Parth Shailesh PATEL, Vadodara (IN); Ashutosh MEHRA, Noida (IN)

(21) Appl. No.: 17/822,029

(22) Filed: Aug. 24, 2022

(51) Int. Cl. G06N 20/00; G06N 5/04

(52) U.S. Cl. CPC G06N 20/00; G06N 5/04

(57) ABSTRACT

Systems and methods for machine learning context based confidence calibration are disclosed. In one embodiment, a processing logic may obtain an image frame; generate, with a first machine learning model, a confidence score, a bounding box, and an instance embedding corresponding to an object instance inferred from the image frame; and compute, with a second machine learning model, a calibrated confidence score for the object instance based on the instance embedding, the confidence score, and the bounding box.

### BACKGROUND

When a machine learning model is used in a task to draw an inference or make a prediction based on input data, the machine learning model will typically also output a confidence score that serves as a relative qualification as to how confident the machine learning model is in the inference or prediction. For example, a confidence score can be modeled as a decimal number between 0 and 1, or a percentage between 0% and 100%. A confidence score approaching 1 (100%) indicates that the machine learning model is strongly confident in its prediction, while a confidence score approaching 0 (0%) indicates that the machine learning model has little confidence in its prediction. A software application can then consider whether or not to use the prediction from the machine learning model from the confidence score, for example based on whether the confidence score at least meets a confidence threshold value.

### SUMMARY

The present disclosure is directed, in part, to improved systems and methods using machine learning context based confidence calibration, substantially as shown and/or described in connection with at least one of the figures, and as set forth more completely in the claims.

Embodiments presented in this disclosure provide for, among other things, a machine learning model based confidence calibrator that incorporates contextual information to enhance the capability of the confidence calibrator to more accurately estimate confidence scores for object inference predictions. More specifically, the contextual information used by the confidence calibrator comprises embedding information represented by a tensor that is computed by a first machine learning model that generated the object inference prediction. The embedding information is therefore an internal representation of the object instance that is produced as the first machine learning model processes the input image during an object detection and/or classification task. The result is a calibrated confidence score that is a more accurate indication of confidence in object instances generated by the first machine learning model than the confidence score computed by the first machine learning model itself.

Other embodiments disclosed herein include the use of the confidence calibrator to detect inconsistent annotations in a ground truth dataset. As one example, during a validation process for the first machine learning model, an image of a validation dataset may be processed that causes the confidence calibrator to compute a calibrated confidence score for an object instance that is substantially lower than the original confidence score computed by the first machine learning model. In response to that deviation, a set of sample images from a training data identified by a similarity search are processed by the first machine learning model and the confidence calibrator in the same manner as the validation dataset. If the confidence calibrator computes a calibrated confidence score for an object instance substantially lower than the original confidence score computed by the first machine learning model, then that is a strong indication that this sample from the training dataset includes a potentially inconsistent ground truth annotation. In some implementations, a clustering algorithm that clusters based on embedding information is applied to object instances that have substantially lower calibrated confidence scores (as compared to their original confidence scores) in order to identify commonly occurring types of ground truth annotation inconsistencies.

### BRIEF DESCRIPTION OF THE DRAWINGS

The embodiments presented in this disclosure are described in detail below with reference to the attached drawing figures, wherein:

FIG. 1 is a block diagram illustrating an operating environment, in accordance with embodiments of the present disclosure;

FIG. 2 is a block diagram illustrating an operating environment, in accordance with embodiments of the present disclosure;

FIGS. 3A and 3B are diagram illustrating example input images, in accordance with embodiments of the present disclosure;

FIG. 4 is a flow chart illustrating an example method embodiment for computing calibrated confidence scores in accordance with embodiments of the present disclosure;

FIG. 5 is a flow chart illustrating an example method embodiment for training a machine learning confidence calibrator in accordance with embodiments of the present disclosure;

FIG. 6 is a block diagram illustrating an operating environment for detecting inconsistent annotations in a ground truth dataset in accordance with embodiments of the present disclosure;

FIGS. 7A and 7B are diagrams illustrating example inconsistent annotations in input images in accordance with embodiments of the present disclosure;

FIG. 8 is a flow chart illustrating a method for detecting inconsistent annotations in a ground truth dataset in accordance with embodiments of the present disclosure;

FIG. 9 is a flow chart illustrating a method for clustering predictions of potential inconsistent annotations in a ground truth dataset in accordance with embodiments of the present disclosure;

FIG. 10 is a diagram illustrating an example computing environment in accordance with embodiments of the present disclosure; and

FIG. 11 is a diagram illustrating an example cloud based computing environment in accordance with embodiments of the present disclosure.

### DETAILED DESCRIPTION

The confidence score generated by a machine learning model serves as a relative qualification as to how confident the machine learning model is in each predictions it generates. A machine learning model can be under-confident, or over-confident, about its predictions and neural networks, such as those used to make object detection or classification inferences, sometimes have a tendency to compute confidence scores that are over-confident. When using machine learning models for real world applications, unbiased confidence score estimates that accurately reflect the uncertainty of predictions are highly desired. This is important because in real-world decision-making systems, machine learning models must not only be accurate but should also indicate when they are likely to be incorrect to allow for alternate decisions.

Confidence calibration is the task of calibrating (that is, adjusting or tuning) the predicted confidence scores produced by a machine learning model to be representative of the true correctness likelihood of the predictions. A confidence calibrator, accordingly, takes as input the originally predicted confidence scores from the machine learning model and outputs calibrated confidence scores. In a classification setting, confidence calibration comprises the task of aligning an average confidence of the machine learning model's predictions to be as close as possible to the accuracy of the model. In an object detection setting, one way to define the confidence calibration task would be to orient the average confidence of predictions to be similar to the model's precision (precision is the fraction of predicted instances that are correct). Confidence calibration techniques help to ensure that confidence scores for predictions are unbiased and can be more reliably used for downstream post processing.

Mathematically, given a classification model h and input data X, a machine learning model's predictions on input data can be expressed as h(X)=(Ŷ, \hat{P}) where Ŷ is a class prediction and \hat{P} is its associated confidence score. Examples of existing techniques for machine learning model confidence calibration include Temperature Scaling, Platt Scaling, Isotonic Regression, and Histogram Binning. Each of these existing techniques aim at learning a function that maps the original confidence score to the calibrated confidence score by minimizing an objective function to arrive at an Expected Calibration Error (ECE). Although existing calibration techniques somewhat reduce the ECE, they do not do so significantly enough for may use case applications—or as effectively as the confidence calibrator embodiments presented in this disclosure—and are not consistent across classes of objects.

Embodiment presented herein incorporate contextual information as input to a machine learning model based confidence calibrator to enhance the capability of the confidence calibrator to more accurately estimate the confidence/correctness of each output prediction. The confidence calibrator disclosed herein provides better confidence estimates that can be useful in several ways such as more precise utilization of downstream heuristics used to post-process a machine learning model's output predictions, better performance monitoring of the machine learning model's predictions on live customer data, and for other inference tasks.

Embodiments described herein include a machine learning model based confidence calibrator to compute a calibrated confidence score corresponding to an object instance generated by a first machine learning model from an input image. The confidence calibrator augments other input data by utilizing embedding information represented by a tensor computed by the first machine learning model. The embedding information is an internal representation of the object instance that is produced as the first machine learning model processes the input image during an object detection and/or classification task. Training the machine learning model of the confidence calibrator to further use embedding information to augment other inputs, results in a more accurate indication of confidence in object instances generated by the first machine learning model than the confidence score computed by the first machine learning model itself.

Other embodiments disclosed herein include the use of the confidence calibrator to detect inconsistent annotations in a ground truth dataset (e.g. training data). As one example, during a validation process for the first machine learning model, an image of a validation dataset may be processed that causes the confidence calibrator to compute a calibrated confidence score for an object instance that is substantially lower than the original confidence score computed by the first machine learning model. In response to that deviation, a similarity search is performed on the associated training dataset based on embedding information. A set of sample images from the training data identified by the similarity search are processed by the first machine learning model and the confidence calibrator in the same manner as the validation dataset. If the confidence calibrator computes a calibrated confidence score for an object instance substantially lower than the original confidence score computed by the first machine learning model, then that is a strong indication that this sample from the training dataset includes a potentially inconsistent ground truth annotation. In some implementations, a clustering algorithm that clusters based on embedding information is applied to object instances that have substantially lower calibrated confidence scores (as compared to their original confidence scores) in order to identify commonly occurring types of ground truth annotation inconsistencies. By using embedding information, confidence score anomalies identified during processing of the relatively small validation dataset are leveraged to intelligently trigger a search for confidence score anomalies for similar object instances in the substantially larger training dataset, resulting in a highly efficient method to detect a set of training set samples having inconsistent ground truth annotations.

The embodiments disclosed herein present several advantages over existing confidence calibrations technologies and uses thereof. For example, the confidence calibrator disclosed herein, by using embedding information to augment other inputs, provides more accurate indications of confidence so that downstream applications that consume the corresponding object instance data can more efficiently and accurately operate when discerning and rejecting low accuracy object instance data in favor of high accuracy object instance data. As a result, computing resources associates with those downstream applications are more efficiently utilized and fewer resources are needed to mitigate determinations made based on overconfidence in machine learning model outputs. Moreover, these embodiments have the advantage of providing technologies for the otherwise difficult task of identifying anomalies in the typically very large sets of training data used to train machine learning modes. Instead of searching the training data for inconsistencies directly, the confidence calibrator instead initially identifies suspect samples in the smaller validation dataset. For example, collected data for real-work datasets is often divided such that 98-99% is used to form the training dataset and just 1-2% used to form the validation dataset. Once suspect samples are identified in the validation dataset, similar samples from the training dataset are selected based on embedding information, which represents a substantially more efficient utilization of computing resources and ultimately improves the underlying functionality of the computing system which can more efficiently identify the training data anomalies. As another advantage, the operation of machine learning models themselves is improved through the use of consistently annotated training data that results from the techniques described herein.

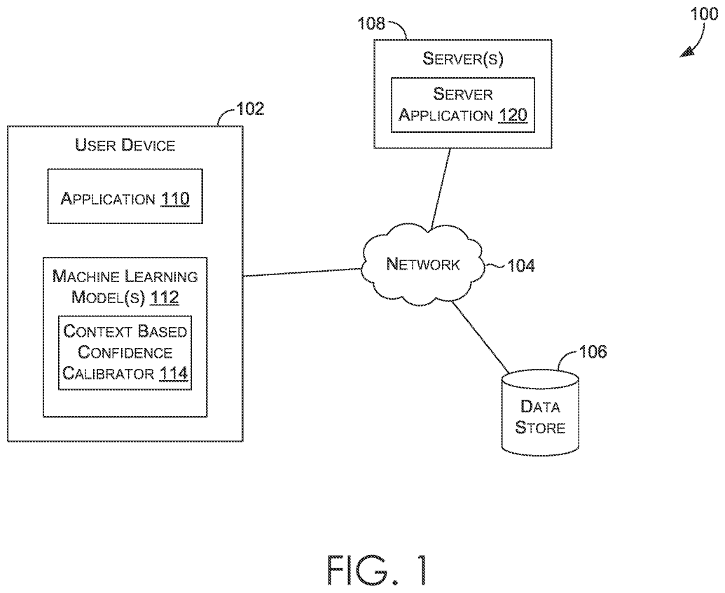

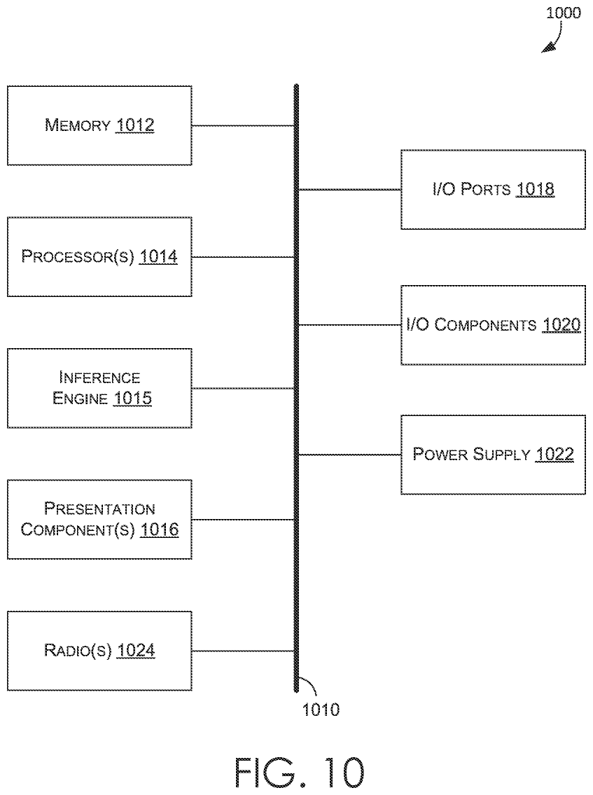

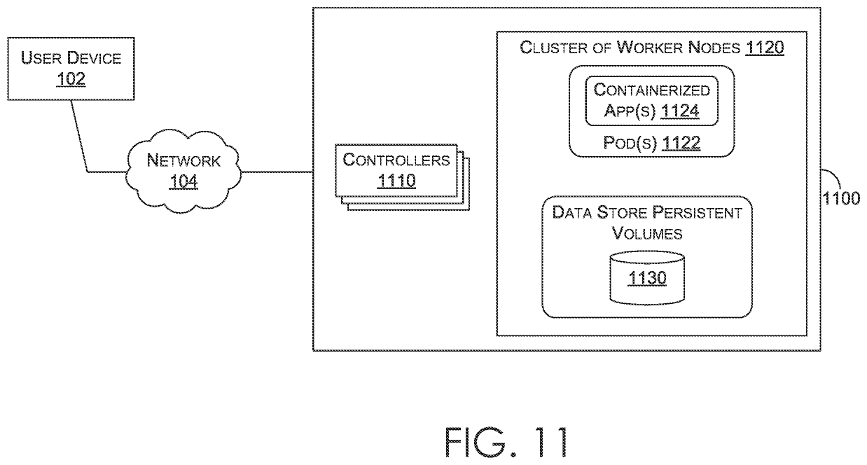

Turning to FIG. 1, FIG. 1 depicts an example configuration of an operating environment 100 in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities are be carried out by hardware, firmware, and/or software. For instance, in some embodiments, some functions are carried out by a processor executing instructions stored in memory as further described with reference to FIG. 10, or within a cloud computing environment as further described with respect to FIG. 11.

It should be understood that operating environment 100 shown in FIG. 1 is an example of one suitable operating environment. Among other components not shown, operating environment 100 includes a user device, such as user device 102, network 104, a data store 106, and one or more servers 108. Each of the components shown in FIG. 1 can be implemented via any type of computing device, such as one or more of computing device 1000 described in connection to FIG. 10, or within a cloud computing environment 1100 as further described with respect to FIG. 11, for example. These components communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, and/or one or more private networks. Where network 104 includes a wireless telecommunications network, components such as a base station, a communications tower, or even access points (as well as other components) to provide wireless connectivity. Networking environments are commonplace in offices, enterprise-wide computer networks, intranets, and the Internet. Accordingly, network 104 is not described in significant detail.

It should be understood that any number of user devices, servers, and other components are employed within operating environment 100 within the scope of the present disclosure. Each component comprises a single device or multiple devices cooperating in a distributed environment.

User device 102 can be any type of computing device capable of being operated by a user. For example, in some implementations, user device 102 is the type of computing device described in relation to FIG. 10. By way of example and not limitation, a user device is embodied as a personal computer (PC), a laptop computer, a mobile device, a smartphone, a tablet computer, a smart watch, a wearable computer, a headset, an augmented reality device, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media includes computer-readable instructions executable by the one or more processors. The instructions are embodied by one or more applications, such as application 110 shown in FIG. 1. Application 110 is referred to as a single application for simplicity, but its functionality can be embodied by one or more applications in practice. As indicated above, the other user devices can include one or more applications similar to application 110.

The image editing application 110 can generally be any application that functions in conjunction with one or more machine learning models 112. In some implementations, the image editing application 110 comprises a web application, which can run in a web browser, and could be hosted at least partially on the server-side of environment 100 (such as by server application 120). It is therefore contemplated herein that “application” be interpreted broadly.

In some embodiments, the application 110 operates in conjunction with one or more machine learning models 112 to evaluate input images to perform object detection and/or classification tasks, which are collectively referred to as instance prediction tasks. Each object detected and/or classified in an input image by the machine learning model is referred to herein as an instance predicted by the machine learning models 112, and an input image can include multiple objects that each result in a respective instance predicted by the machine learning models 112. For example, in some embodiments, an input image comprises a page of a document that includes discernable objects in the form of one or more regions of text (e.g., a column, a paragraph), headings, headers and footers, lists, tables, and/or graphical figures (e.g., an illustration, a photograph). In some embodiments, for each object identified by the machine learning model 112, the machine learning model 112 predicts an object instance that includes at least a bounding box that defines a boundary around the object, a classification of the object within the bounding box, and a confidence score that indicates a probability of the prediction being correct. As further explained below, the machine learning model 112 includes or is otherwise coupled to a context based confidence calibrator 114 that further calibrates the confidence scores provided to the application 110.

In some embodiments, the application 110 determines whether to utilize an instance prediction computed by the machine learning model 112 based on the confidence score corresponding to that instance. For example, in some implementations, the application 110 will utilize any instance prediction having a corresponding confidence score greater than a predetermined confidence threshold, and disregard any instance prediction having a corresponding confidence score less than the predetermined confidence threshold.

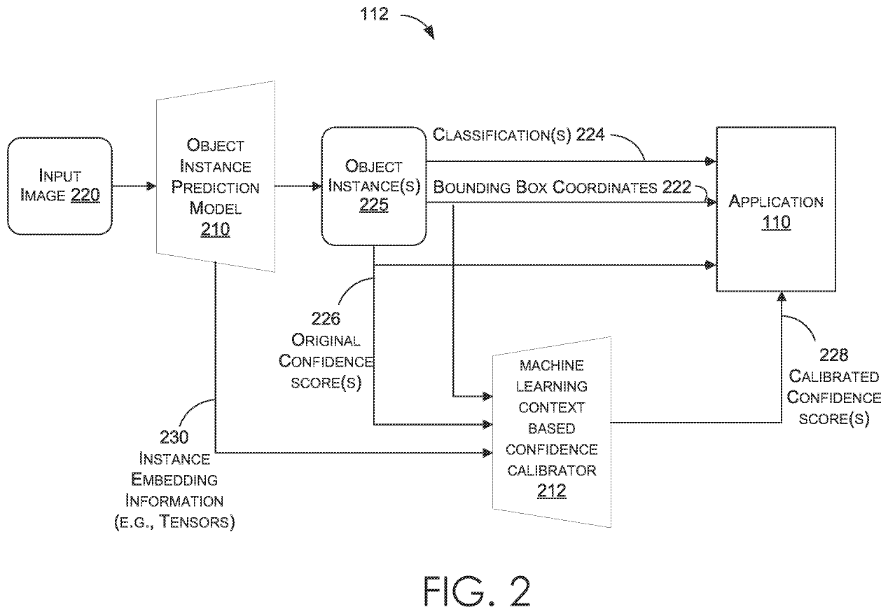

Referring now to FIG. 2, an operating environment is disclosed where the one or more machine learning models 112 are shown as comprising a machine learning based object instance prediction model 210 and a machine learning context based confidence calibrator 212. In some embodiments, machine learning context based confidence calibrator 212 implements the context based confidence calibrator 114 of FIG. 1. The machine learning based object instance prediction model 210 and the machine learning based confidence calibrator 212 can be implemented together using a common machine learning model, or implemented separately using distinct machine learning models.

The object instance prediction model 210 executes the task of predicting object instances 225 from an input image 220. The object instance prediction model 210 generates, for each object instance 225, coordinates of a bounding box 222 (with reference to the input image), a classification 224 of the object within a bounding box, and a confidence score 226 that indicates a probability of the object instance prediction being correct.

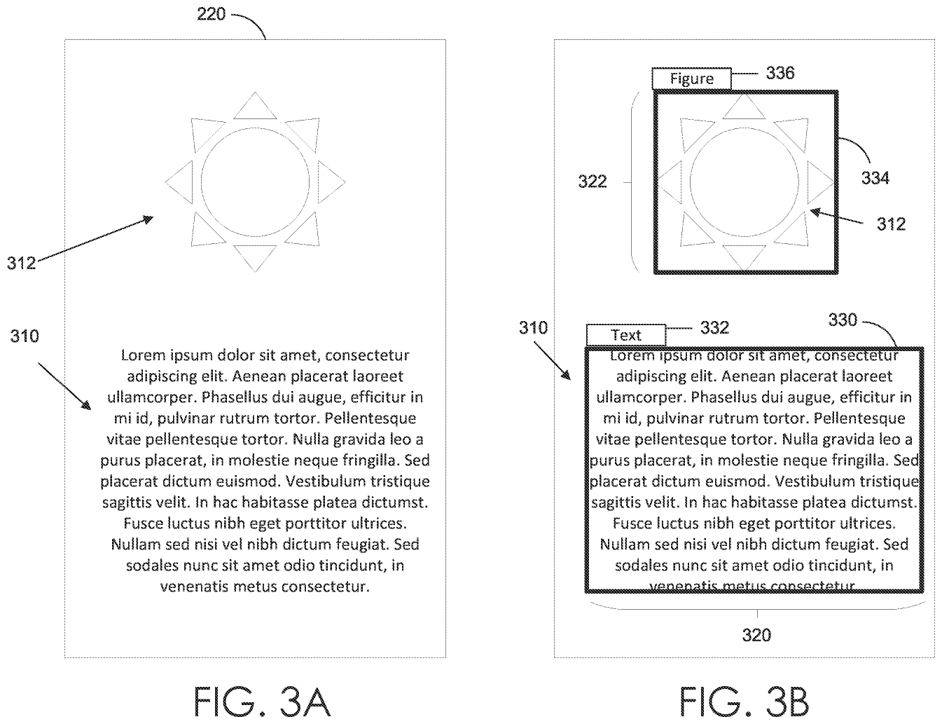

For example, referring to FIGS. 3A and 3B, an example input image 220 is illustrated comprising objects that include a region of text 310 and an illustrative FIG. 312. From this input image 220, the object instance prediction model 210 generates a first object instance prediction 320 comprising a first bounding box 330 around the region of text 310 and a classification of that object instance as text (as shown at 332). The object instance prediction model 210 also generates a second object instance prediction 322 comprising a second bounding box 334 around the FIG. 312 and a classification of that object instance as a figure (as shown at 336). For each of the first object instance prediction 320 and the second object instance prediction 322, the object instance prediction model 210 further computes a respective confidence score 226.

The confidence score 226 computed by the object instance prediction model 210 is referred to herein as an “original confidence” value because it is the native confidence score generated by the object instance prediction model 210 itself. As discussed above, neural networks, such as used to implement object instance prediction model 210, often have a tendency to compute confidence scores that are over-confident. In such cases, the application 110 may detrimentally input and utilize predicted object instances 225 based on an inaccurately high assessment of the accuracy of the predicted object instances 225. Alternately, under-confident computation of confidence score can also have adverse consequence for the application 110. For example, the application 110 may detrimentally disregard a predicted object instance 225 that includes an accurate prediction regarding an object appearing in the input image 220.

The confidence calibrator 212 performs the task of calibrating (e.g., adjusting or tuning) the predicted original confidence scores 226 to produce calibrated confidence scores 228 that are more closely representative of the true probability of correctness of the object instance predictions 225. More specifically, the confidence calibrator 212 comprises a machine learning model that takes as input from the object instance prediction model 210, for each object instance 225, the corresponding bounding box coordinates 222 and original confidence score 226 and further incorporates extra contextual information in the form of instance embedding information 230 corresponding to each object instance. That is, the confidence calibrator 212 utilizes a tensor comprising embedding information computed by the object instance prediction model 210 during the process of predicting object instances 225. The embedding information 230 is an internal representation of the object instance that is computed as the object instance prediction model 210 processes the input image 220 during an object detection and/or classification task. Training the machine learning model of the confidence calibrator 212 to use embedding information 230 to augment the other inputs (bounding box coordinates 222 and original confidence scores 226) results in a more accurate indication of confidence in the object instances 225 generated by the object instance prediction model 210 than the confidence scores 226 computed by the object instance prediction model 210 itself. The calibrated confidence scores 228 computed by the confidence calibrator 212 do not improve the accuracy of the object instances 225 predictions themselves, but rather represent an improved understanding of the accuracy of the predictions. As such, in embodiments, the application 110 inputs and utilizes the calibrated confidence scores 228 to make better informed determinations regarding whether an object instance 225 is a sufficiently accurate prediction to use. In some embodiments, such as discussed below, the application 110 uses both the calibrated confidence score 228 and original confidence score 226 for an object instance 225 to make further determinations regarding a predicted object instance 225.

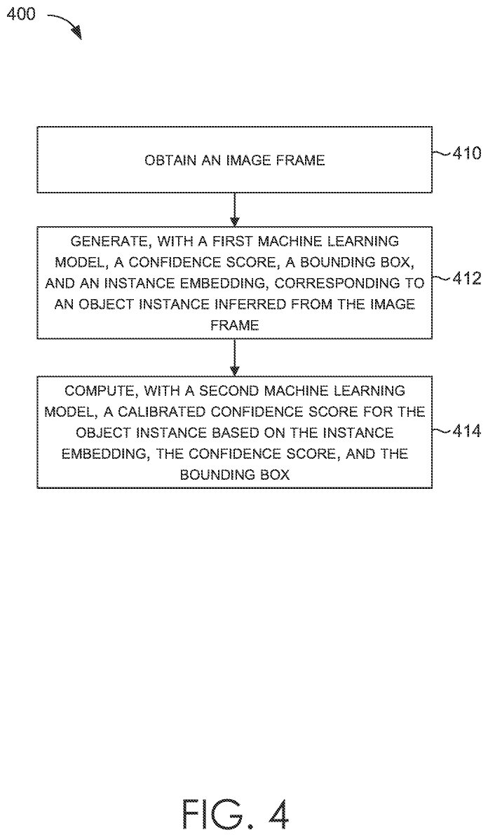

FIG. 4. is a diagram illustrating a method for computing calibrated confidence scores for instance prediction tasks in accordance with an example embodiment. It should be understood that the features and elements described herein with respect to the method 400 of FIG. 4 can be used in conjunction with, in combination with, or substituted for elements of, any of the other embodiments discussed herein and vice versa. Further, it should be understood that the functions, structures, and other descriptions of elements for embodiments described in FIG. 4 can apply to like or similarly named or described elements across any of the figures and/or embodiments described herein and vice versa. In some embodiments, elements of method 400 are implemented using the object instance prediction model 210 and/or the machine learning context based confidence calibrator 212 disclosed above, and executed as operations by one or more processing device. The method 400 at 410 includes obtaining an image frame (e.g., an input image 220). The image frame comprises any digitized form of image or composite of images of at least one object such as, but not limited to, document pages, drawing sheets, scanned pages, photographs, illustrations, or video frames of a video stream or file. The method includes at 412 generating, with a first machine learning model, a confidence score, a bounding box, and an instance embedding, corresponding to an object instance inferred from the image frame. The instance embedding comprises a tensor computed by the first machine learning model corresponding at least in part to the object instance. As an example, where the image frame comprises a document page, the object instance are generated from an object in the input image such as one or more regions of text (e.g., a column, a paragraph), headings, headers and footers, lists, tables, and/or graphical figures (e.g., an illustration, a photograph). In some embodiments, the object instance are generated by the first machine learning model from elements appearing in photographs or video frames in the input image such as people, faces, animals, vehicles, buildings, signage, or other visual elements that the first machine learning model is trained to detect and/or recognize. For example, in some embodiments, the user device 102 comprises a self-driving vehicle and the application 110 uses the machine learning models 112 with the context based confidence calibrator 114 to identify traffic control signs (e.g., stop signs, speed limit signs), other vehicles, and/or pedestrians.

The method includes at 414, computing, with a second machine learning model (such as confidence calibrator 212), a calibrated confidence score for the object instance based on the instance embedding, the confidence score and the bounding box. As discussed above, the second machine learning model is trained to use embedding information to augment the other inputs (e.g., bounding box coordinates and original confidence scores 226) to computed a more accurate indication of confidence in the object instances generated by the first machine learning model than the confidence scores computed by the first machine learning model.

Because the tensor values of the embedding information 230 are internally computed elements of the object instance prediction model 210, their values are functions, at least in part, of the weighting matrixes and biases applied from training of the implementing neural network of the object instance prediction model 210. The machine learning context based confidence calibrator 212 is therefore trained separately from the training of the first machine learning model using a second training set, after training of the object instance prediction model 210 with a first training set is completed. Parameters of the object instance prediction model 210 are not adjusted while training the confidence calibrator 212 because such adjustment would affect how inference embedding information is represented by the tensor values.

In some embodiments, the confidence calibrator 212 is trained using a binary classification process. In such embodiments, a training dataset comprising input images for training the confidence calibrator 212 is first fed into the object instance prediction model 210 to generate object instances 225 as discussed above. For each object instance produced from an input image, the object instance prediction model 210 computes coordinates of a bounding box 222, an original confidence score 226, an instance embedding information 230, and optionally a classification 224, which is input to the confidence calibrator 212 under training. The confidence calibrator 212 under training generates a calibrated confidence score which can be compared to a labeled ground truth image of the input image to compute a binary classification score. As an example, given the predicted bounding box coordinates 222, a binary classification score of 1 is assigned if the labeled ground truth image has a corresponding bounding box (e.g., a bounding box generally at the same coordinates and/or same classification), and a score of 0 if there is no corresponding bounding box found in the labeled ground truth image. The binary classification score is fed back as a training correction for the confidence calibrator 212, for example to optimize a linear loss equation by iteratively adjusting weights matrix and/or biases of the machine learning model used to implement the confidence calibrator 212. In some embodiments, the confidence calibrator 212 is fed a training correction that is based on a difference between the calibrated confidence score produced by the confidence calibrator 212 under training, and the binary classification score.

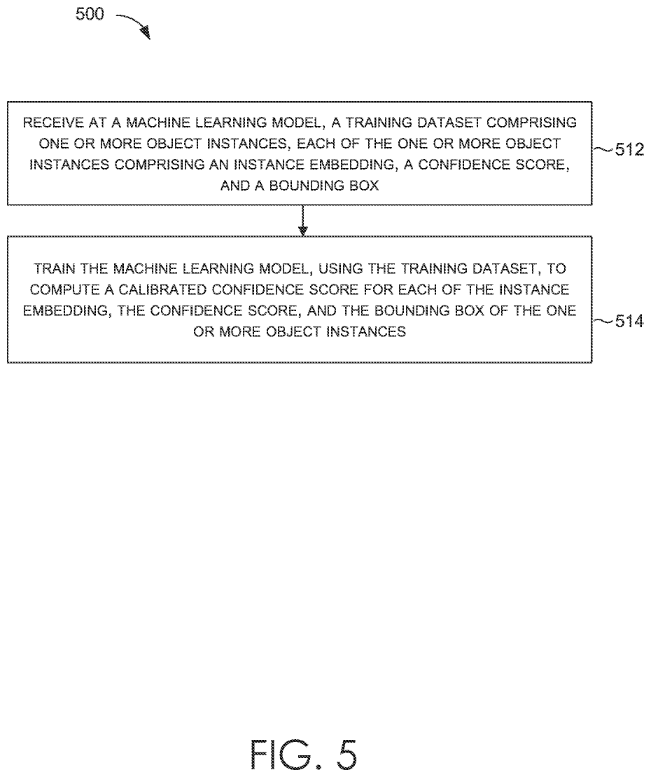

FIG. 5. is a diagram illustrating a method for training a machine learning confidence calibrator in accordance with an example embodiment. It should be understood that the features and elements described herein with respect to the method 500 of FIG. 5 can be used in conjunction with, in combination with, or substituted for elements of, any of the other embodiments discussed herein and vice versa. Further, it should be understood that the functions, structures, and other descriptions of elements for embodiments described in FIG. 5 can apply to like or similarly named or described elements across any of the figures and/or embodiments described herein and vice versa. In some embodiments, elements of method 500 are implemented using the object instance prediction model 210 and/or machine learning context based confidence calibrator 212 disclosed above, and executed as operations by one or more processing device.

The method 500 at 512 includes receiving at a machine learning model, a training dataset comprising one or more object instances, each of the one or more object instances comprising an instance embedding, a confidence score, and a bounding box. In some embodiments, the training dataset is generated by applying an input image comprising an input image to a trained first machine learning model. The training first machine learning model generates the object instances from the input image and also computes the confidence score, the bounding box, and a tensor representing the instance embedding information for each object instance.

The method 500 at 514 includes training the machine learning model, using the training dataset, to compute a calibrated confidence score for each of the instance embedding, the confidence score, and the bounding box of the one or more object instances. As mentioned above, the tensor values of the embedding information are internally computed elements of the first machine learning model and for that reason, training of the confidence calibrator (the second machine learning model) is perform using after training of the object instance prediction model (the first machine learning model) is completed.

In some embodiments, the method further includes computing a binary classification score for the bounding box based on when the bounding box corresponds to an annotated ground truth bounding box. The machine learning model under training generates an accuracy prediction (a calibrated confidence score), and the location of the predicted bounding box is compared to a labeled ground truth image of the input image to the first machine learning model to compute a binary classification score. For example, a binary classification score of 1 is assigned if the labeled ground truth image has a corresponding bounding box (e.g., a bounding box generally at the same coordinates and/or same classification), and a score of 0 if there is no corresponding bounding box in the labeled ground truth image. The binary classification score is fed back as a training correction for the confidence calibrator machine learning model. In some embodiments, the training correction is used to optimize a linear loss equation by iteratively adjusting weights matrix and/or biases of the confidence calibrator machine learning model. In some embodiments, the machine learning model under training is fed a training correction that is based on a difference between the calibrated confidence score produced by the second machine learning, and the binary classification score. Accordingly, the method in some embodiments further includes adjusting the second machine learning model based on a difference between the calibrated confidence score and the binary classification score.

In some embodiments, the object instance prediction model 210 and machine learning context based confidence calibrator 212 are used to execute a process to detect inconsistent annotations in a ground truth dataset (e.g., training data). Inconsistencies in the annotation of collected ground truth data that is used for training a machine learning model can lead the machine learning model to making errors in object detection and classification tasks.

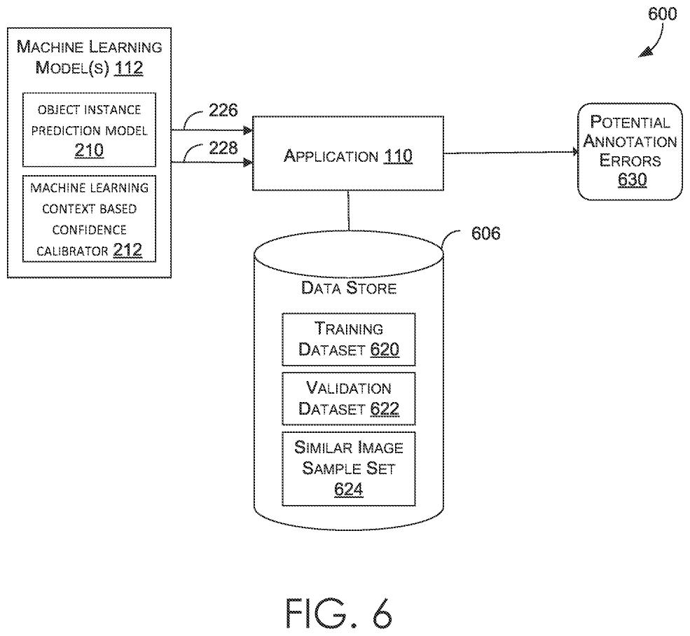

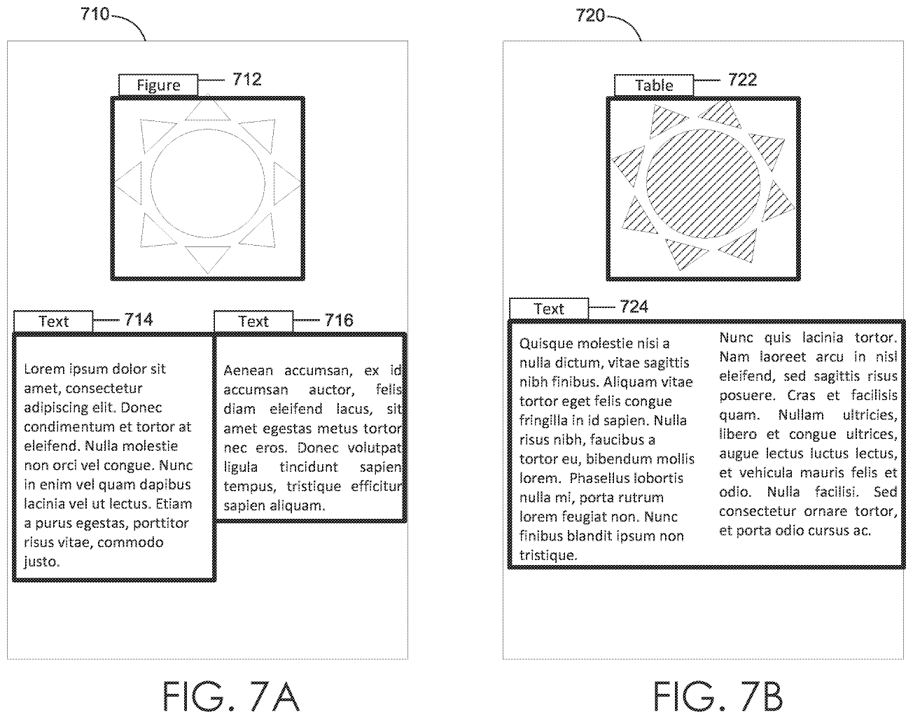

Referring now to FIG. 6, in some such implementations, the application 110 is coupled to a data store 606 (which can be a component of user device 102, or a network hosted data store such as data store 106 in FIG. 1). Data store 606 a training dataset 620, validation dataset 622, and a similar image sample set 624. Moreover, in some embodiments, the application 110 is implemented as a server application 120 host by a server 108. In one embodiments during operation of a validation process for the object instance prediction model 210, an image from validation dataset 622 can cause the confidence calibrator 212 to compute a calibrated confidence score 228 for an object instance that is substantially lower than the original confidence score 226 computed by the object instance prediction model 210 (e.g., deviating by more than a predefine threshold). As discussed above, such deviations are indicators of potential annotation inconsistencies in training data used to train the object instance prediction model 210. FIGS. 7A and 7B provide examples of potential inconsistent annotations of ground truth data. For the purpose of example, the image sample 710 represents an annotated ground truth sample from the validation dataset 622, and the image sample 720 represents an annotated ground truth sample from the training dataset 620. The training dataset 620 has an association with the object instance prediction model 210 in that the training dataset 620 is the set of training data used to train the object instance prediction model 210. As evident by these two figures, although they are substantially similar in structure and appearance, they are not consistent with respect to how they are annotated. The image sample 710 includes an object comprising an illustrative figure that is annotated as a “Figure” as shown at 712. The image sample 710 also includes two text objects each comprising a column of text that are each separately annotated as “Text” as shown at 714 and 716. The image sample 720 includes an object comprising an illustrative figure that was incorrectly annotated as a “Table” as shown at 722. The image sample 710 also includes two text objects each comprising a column of text, but they are annotated together as a single text object as shown at 724. Manifestations of such inconsistencies can be detected when the confidence calibrator 212 computes a calibrated confidence score 228 for image sample 710 that is substantially lower than the original confidence score 226 computed by the object instance prediction model 210 during testing using the validation dataset 622. That deviation in-and-of itself is not directly an indication that the annotation of image sample 710 is in error, but is instead an initial indication of a potential inconsistency sufficient to trigger a further analysis. Accordingly, in embodiments, in response to the deviation exceeding an initial threshold, application 110 performs a similarity search on the associated training dataset 620 utilizing the embedding information produced by the object instance prediction model 210.

Returning again to FIG. 6, the similarity search is performed by the application 110. The similarity search compares the tensor of embedding information for predicted object instances from validation dataset 622 that had the substantially lower calibrated confidence score 228 as compared to the original confidence score 226 (such as image sample 710), with the tensor of the embedding information of predicted object instances from the training dataset 620 (such as image sample 720).

In different embodiments, various techniques can be used to determine the similarity between tensors from embedding information of two predicted object instances. For example, in one embodiment, a Euclidian distance is computed between the tensor of the embedding information from the validation dataset image sample 710 and the embedding information from the training dataset image sample 720. When the Euclidian distance is less than a threshold, the corresponding image object instances are considered similar, and when the Euclidian distance is greater than a threshold, the corresponding image object instances are considered non-similar. The results of the similarity search are saved as the similar image sample set shown at 624. The object of the search is thus to identify image objects from the training dataset 620 that are similar in appearance to the image object of the suspect validation data image sample.

Once compiled, the set of similar image samples 624 identified by the similarity search are processed by the object instance prediction model 210 and confidence calibrator 212 in the same manner as the validation dataset 622. When the confidence calibrator 212 processes the set of sample image samples 624 and computes a calibrated confidence score 228 for an object instance that is substantially lower than the original confidence score 226 computed by the object instance prediction model 210, then that deviation is now a strong indication that this image sample from the training dataset 620 includes a potentially inconsistent ground truth annotation. In some embodiments, the application 110 outputs a report or other form of potential training set annotation errors, such as shown at 630. By using embedding information, confidence score anomalies identified during processing of the relatively small validation dataset 622 are used as the basis to trigger a search for confidence score anomalies occurring in similar object instances in the substantially larger training dataset 620, resulting in a highly efficient method to detect when a set of training set samples has inconsistent ground truth annotations.

Given the output produced by the application 110 of potential training set annotation errors 630, several mitigation actions can be performed. A first option is to cull from the training dataset 620 image samples that are flagged as having potentially inconsistent ground truth annotation. The object instance prediction model 210 would then be re-initialized and re-trained using the now redacted training dataset 620, followed by re-initialization and re-training of the confidence calibrator 212 as described above. While this option does avoid the training ambiguities caused by inconsistent ground truth annotation, otherwise valid ground truth data that was collected at some expense can also be discarded. That said, if ample training data is already collected, discarding the affected image samples from the training data may not have detrimental consequences and can be the least costly option. As a second option, the image samples from the set of similar image samples 624 can be re-annotated by human labelers that were made aware of the inconsistent ground truth annotations, and the corresponding image samples from the training dataset 620 replaced with the re-annotated sample. The object instance prediction model 210 could then be re-initialized and re-trained using the now updated training dataset 620, followed by re-initialization and re-training of the confidence calibrator 212 as described above. As a potential third option, if the number of training data samples having inconsistent ground truth annotations is determined to be relatively small (less than a predetermine percentage of the total number of samples in the training dataset 620, for example), then the inconsistencies may simply be ignored as likely to have only a negligible impact on the ability of the object instance prediction model 210 to accurately perform instance prediction tasks. This third option further avoid the need to re-initialize and re-train the object instance prediction model 210 and confidence calibrator 212.

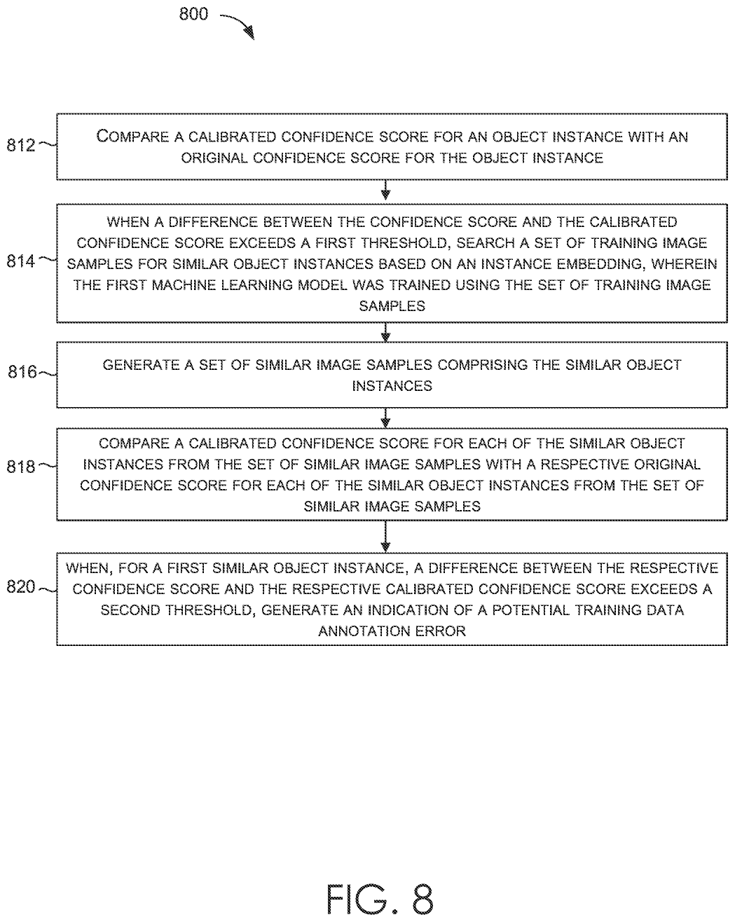

FIG. 8 is a diagram illustrating a method for detecting potential training data annotation inconsistencies in accordance with an example embodiment. It should be understood that the features and elements described herein with respect to the method 800 of FIG. 8 can be used in conjunction with, in combination with, or substituted for elements of, any of the other embodiments discussed herein and vice versa. Further, it should be understood that the functions, structures, and other descriptions of elements for embodiments described in FIG. 8 can apply to like or similarly named or described elements across any of the figures and/or embodiments described herein and vice versa. In some embodiments, elements of method 800 are implemented using the application 110, object instance prediction model 210 and/or machine learning context based confidence calibrator 212 disclosed above, and executed as operations by one or more processing device.

The method 800 includes at 812 comparing a calibrated confidence score for an object instance with an original confidence score for the object instance. The original confidence score is generated by a first machine learning model that generated the object instance, and the calibrated confidence score is generated by a second machine learning model as discussed here. The first machine learning model computes the original confidence score, a bounding box, and embedding information corresponding at least in part to the object instance. When a difference between the confidence score and the original calibrated confidence score exceeds a first threshold, the method 800 proceeds to 812 with searching a set of training image samples for similar object instances based on an instance embedding, wherein the first machine learning model was trained using the set of training image samples. A deviation in excess of the threshold is not directly an indication that an annotation error, but can be used as a trigger for further analysis. In response to the deviation exceeding this threshold, the method proceeds to 816 with generating a set of similar image samples comprising the similar object instances from the set of training image samples. In some embodiments, the application 110 performs the similarity search on the associated training dataset 620 utilizing the embedding information produced by the object instance prediction model 210. The set of similar image samples comprises the similar object instances from the set of training image samples. For example, in one embodiment, similarity is based on a Euclidian distance computed between the tensor of the embedding information from the validation dataset image sample and the embedding information from the training dataset image sample. When the Euclidian distance is less than a threshold, the corresponding image object instances are considered similar, and when the Euclidian distance is greater than a threshold, the corresponding image object instances are considered non-similar.

At 818 the method 800 includes comparing a calibrated confidence score for each of the similar object instances from the set of similar image samples with a respective original confidence score for each of the similar object instances from the set of similar image samples. At 820, when a difference between the respective confidence score and the respective calibrated confidence score exceeds a second threshold for a first similar object instance of the set of similar image samples, the method 800 includes generating an indication of a potential training data annotation error. For example, the indication of a potential training data annotation error can comprise a report, display, or other output that lists or displays the training data with suspect annotations.

In some implementations, a clustering algorithm is applied that uses embedding information from object instances with suspect annotations in order to identify the most commonly occurring type of ground truth annotation inconsistencies. For example, in one embodiment, the application 110 includes a clustering algorithm that is applied to object instances that have substantially lower calibrated confidence scores versus original confidence scores. For example, once the validation dataset 622 is process during testing of the object instance prediction model 210, for object instances having is a significant deviation (e.g. a decrease greater than a threshold) between the original and calibrated confidence scores, the application 110 can execute the clustering algorithm to cluster the object instances based on their embedding information. The clustering is performed as a function of embedding information tensor similarity, resulting in a collection of clusters each representing a different type of potential ground truth annotation errors.

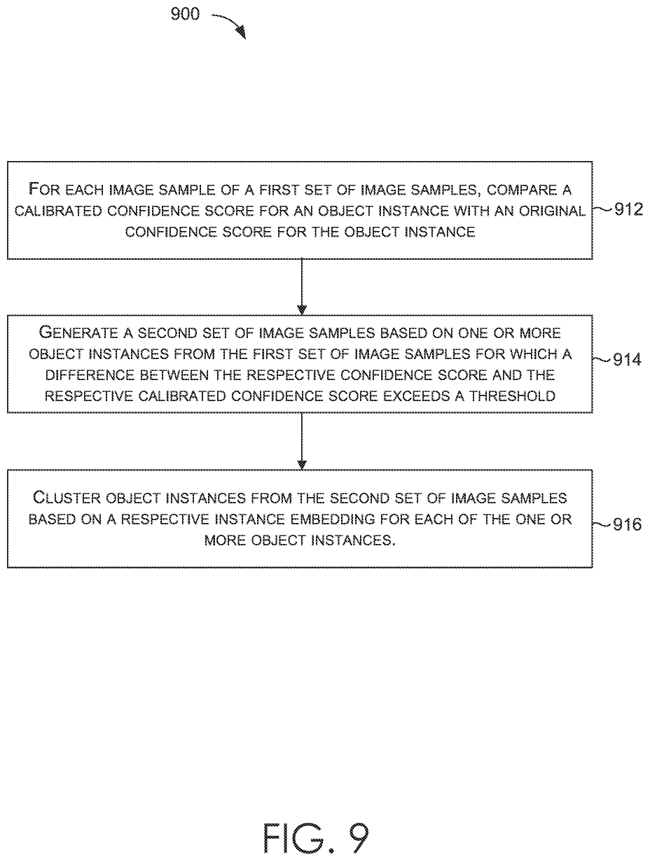

Given the clustering produced by the application 110 of potential training set annotation errors, several mitigation actions are available. For example, in one implementation, clusters having fewer that a predefined threshold of members are ignored as de minimis. For clusters having a greater number of members than a threshold, a first option is to cull from the training dataset image samples that are included in that cluster. The object instance prediction model 210 could then be re-initialized and re-trained using the now redacted training dataset, followed by re-initialization and re-training of the confidence calibrator as described above. As a second option, the image samples includes in a cluster are re-annotated by human labelers that were made aware of the inconsistent ground truth annotations, and the corresponding image samples from the training dataset replaced with the re-annotated samples. The object instance prediction model could then be re-initialized and re-trained using the now updated training dataset, followed by re-initialization and re-training of the confidence calibrator as described above. FIG. 9 is a diagram illustrating a method for clustering predictions of potential inconsistent annotations in a dataset in accordance with an example embodiment. It should be understood that the features and elements described herein with respect to the method 900 of FIG. 9 can be used in conjunction with, in combination with, or substituted for elements of, any of the other embodiments discussed herein and vice versa. Further, it should be understood that the functions, structures, and other descriptions of elements for embodiments described in FIG. 9 can apply to like or similarly named or described elements across any of the figures and/or embodiments described herein and vice versa. In some embodiments, elements of method 900 are implemented using the object instance prediction model 210 and/or machine learning context based confidence calibrator 212 disclosed above, and executed as operations by one or more processing device.

The method 900 includes at 912, for each image sample of a first set of image samples, compare a calibrated confidence score for an object instance with an original confidence score for the object instance. In some embodiments, a set of object instances is generated from the first set of image samples by a first machine learning model, where the first machine learning model computes a respective confidence score, a bounding box, and instance embedding information for each object instance. A respective calibrated confidence score for each object instance is computed with a second machine learning model based on the instance embedding, the confidence score and the bounding box. At 914, the method 900 includes generating a second set of image samples based on one or more object instances from the first set of image samples for which a difference between the respective confidence score and the respective calibrated confidence score exceeds a threshold. Object instances from the second set of image samples are clustered at 916 based on respective instance embedding's for each of the one or more object instances. Various error buckets are thus generated by clustering predictions of potential inconsistent annotations flagged by the context-based calibrator.

With regard to FIG. 10, one exemplary operating environment for implementing aspects of the technology described herein is shown and designated generally as computing device 1000. Computing device 1000 is just one example of a suitable computing environment and is not intended to suggest any limitation as to the scope of use or functionality of the technology described herein. Neither should the computing device 1000 be interpreted as having any dependency or requirement relating to any one or combination of components illustrated.

The technology described herein can be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein, including the object instance prediction model 210, machine learning context based confidence calibrator 212 and/or the application 110 (for example), can be practiced in a variety of system configurations, including handheld devices, consumer electronics, general-purpose computers, and specialty computing devices. Aspects of the technology described herein can also be practiced in distributed computing environments where tasks are performed by remote-processing devices that are linked through a communications network such as network 104.

With continued reference to FIG. 10, computing device 1000 includes a bus 1010 that directly or indirectly couples the following devices: memory 1012, one or more processors 1014, a neural network inference engine 1015, one or more presentation components 1016, input/output (I/O) ports 1018, I/O components 1020, an illustrative power supply 1022, and one or more radio(s) 1024. Bus 1010 represents one or more busses (such as an address bus, data bus, or combination thereof). Although the various blocks of FIG. 10 are shown with lines for the sake of clarity, it should be understood that one or more of the functions of the components can be distributed between components. For example, a presentation component 1016 such as a display device (e.g., which can be used to by application 110 to display various outputs such as but not limited to confidence scores, output images annotated with bounding boxes) based on object instances, and/or potential annotation errors) can also be considered an I/O component 1020. The diagram of FIG. 10 is merely illustrative of an exemplary computing device that can be used in connection with one or more aspects of the technology described herein. Distinction is not made between such categories as “workstation,” “server,” “laptop,” “tablet,” “smart phone” or “handheld device,” as all are contemplated within the scope of FIG. 10 and refer to “computer” or “computing device.”

Memory 1012 includes non-transient computer storage media in the form of volatile and/or nonvolatile memory. The memory 1012 can be removable, non-removable, or a combination thereof. Exemplary memory includes solid-state memory, hard drives, and optical-disc drives. Computing device 1000 includes one or more processors 1014 that read data from various entities such as bus 1010, memory 1012, or I/O components 1020. Presentation component(s) 1016 present data indications to a user or other device and in some embodiments, comprises a human-machine interface (HMI) display for presenting a user interface for application 110.

Neural network inference engine 1015 comprises a neural network coprocessor, such as but not limited to a graphics processing unit (GPU), configured to execute a deep neural network (DNN) and/or machine learning models. In some embodiments, machine learning models 112 including one or both of the object instance prediction model 210 and machine learning context based confidence calibrator 212 are implemented at least in part by the neural network inference engine 1015. Exemplary presentation components 1016 include a display device, speaker, printing component, and vibrating component. I/O port(s) 1018 allow computing device 1000 to be logically coupled to other devices including I/O components 1020, some of which can be built in. Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which can include, by way of example only, a pen or a stylus) are provided in order to digitally capture freehand user input. The connection between the pen digitizer and processor(s) 1014 can be direct or via a coupling utilizing a serial port, parallel port, and/or other interface and/or system bus known in the art. Furthermore, the digitizer input component can be a component separated from an output component such as a display device, or in some aspects, the usable input area of a digitizer can be coextensive with the display area of a display device, integrated with the display device, or can exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs can be interpreted as ink strokes for presentation in association with the computing device 1000. These requests can be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 1000. The computing device 1000, in some embodiments, is be equipped with depth cameras, such as stereoscopic camera systems, infrared camera systems, RGB camera systems, and combinations of these, for gesture detection and recognition. Additionally, the computing device 1000, in some embodiments, is equipped with accelerometers or gyroscopes that enable detection of motion. The output of the accelerometers or gyroscopes can be provided to the display of the computing device 1000 to render immersive augmented reality or virtual reality. A computing device, in some embodiments, includes radio(s) 1024. The radio 1024 transmits and receives radio communications. The computing device can be a wireless terminal adapted to receive communications and media over various wireless networks.

FIG. 11 is a diagram illustrating a cloud based computing environment 1100 for implementing one or more aspects of the object instance prediction model 210, machine learning context based confidence calibrator 212 and/or the application 110 discussed with respect to any of the embodiments discussed herein. Cloud based computing environment 1100 comprises one or more controllers 1110 that each comprises one or more processors and memory, each programmed to execute code to establish a cloud base computing platform executing at least part of the object instance prediction model 210, machine learning context based confidence calibrator 212 and/or the application 110.

In one embodiment, the one or more controllers 1010 comprise server components of a data center. For example, in one embodiment the object instance prediction model 210, machine learning context based confidence calibrator 212 and/or the application 110 are virtualized network services running on a cluster of worker nodes 1120 established on the controllers 1110. For example, the cluster of worker nodes 1120 can include one or more of Kubernetes (K8s) pods 1122 orchestrated onto the worker nodes 1120 to realize one or more containerized applications 1124 for the object instance prediction model 210, machine learning context based confidence calibrator 212 and/or the application 110. In some embodiments, the user device 102 can be coupled to the controllers 1110 by a network 104 (for example, a public network such as the Internet, a proprietary network, or a combination thereof). In such an embodiment, one or more of the object instance prediction model 210, machine learning context based confidence calibrator 212 and/or the application 110 are at least partially implemented by the containerized applications 1124. In some embodiments the cluster of worker nodes 1120 includes one or more one or more data store persistent volumes 1130 that implement the data store 106. In some embodiments training and validation datasets 620, 622 and or similar image samples set 624 are saved to the data store persistent volumes 1030 and/or other ground truth data for training the machine learning models 112 is received from the data store persistent volumes 1130.

In various alternative embodiments, system and/or device elements, method steps, or example implementations described throughout this disclosure (such as the application 110, server application 120, machine learning mode(s) 112, context based confidence calibrator 114, object instance prediction model 210, and/or machine learning context based confidence calibrator 212, or any of the modules or sub-parts of any thereof, for example) can be implemented at least in part using one or more computer systems, field programmable gate arrays (FPGAs), application specific integrated circuits (ASICs) or similar devices comprising a processor coupled to a memory and executing code to realize that elements, processes, or examples, said code stored on a non-transient hardware data storage device. Therefore, other embodiments of the present disclosure can include elements comprising program instructions resident on computer readable media which when implemented by such computer systems, enable them to implement the embodiments described herein. As used herein, the terms “computer readable media”, “computer readable medium”, and “computer storage media” refer to tangible memory storage devices having non-transient physical forms and includes both volatile and nonvolatile, removable and non-removable media. Such non-transient physical forms can include computer memory devices, such as but not limited to: punch cards, magnetic disk or tape, or other magnetic storage devices, any optical data storage system, flash read only memory (ROM), non-volatile ROM, programmable ROM (PROM), erasable-programmable ROM (E-PROM), Electrically erasable programmable ROM (EEPROM), random access memory (RAM), CD-ROM, digital versatile disks (DVD), or any other form of permanent, semi-permanent, or temporary memory storage system of device having a physical, tangible form. By way of example, and not limitation, computer-readable media can comprise computer storage media and communication media. Computer storage media does not comprise a propagated data signal. Program instructions include, but are not limited to, computer executable instructions executed by computer system processors and hardware description languages such as Very High Speed Integrated Circuit (VHSIC) Hardware Description Language (VHDL).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and can be employed without reference to other features and sub-combinations and are contemplated within the scope of the claims.

In the preceding detailed description, reference is made to the accompanying drawings which form a part hereof wherein like numerals designate like parts throughout, and in which is shown, by way of illustration, embodiments that can be practiced. It is to be understood that other embodiments can be utilized and structural or logical changes can be made without departing from the scope of the present disclosure. Therefore, the preceding detailed description is not to be taken in the limiting sense, and the scope of embodiments is defined by the appended claims and their equivalents.

What is claimed is:

1. A system comprising:
a memory component; and
one or more processing devices coupled to the memory component, the one or more processing devices to perform operations comprising:
obtaining an image frame;
generating, with a first machine learning model, a confidence score, a bounding box, and an instance embedding, corresponding to an object instance inferred from the image frame; and
computing, with a second machine learning model, a calibrated confidence score for the object instance based on the instance embedding, the confidence score, and the bounding box.

2. The system of claim 1, wherein the first machine learning model and the second machine learning model are executed via a neutral network.

3. The system of claim 1, wherein the image frame comprises an image of at least one of text, a graphic, a video image frame, and a photograph.

4. The system of claim 1, wherein the first machine learning model is trained to generate the object instance based on a first training set comprising image frame samples; and
wherein the second machine learning model is trained separately from the first machine learning model using a second training set after training of the first machine learning model with the first training set is completed.

5. The system of claim 4, wherein the second machine learning model is trained by:
computing a binary classification score for the bounding box responsive to determining that the bounding box corresponds to an annotated ground truth bounding box; and
adjusting the second machine learning model based on a difference between the calibrated confidence score and the binary classification score.

6. The system of claim 1, the operations further comprising:
responsive to determining that a difference between the confidence score and the calibrated confidence score exceeds a first threshold, searching a set of training image samples for similar object instances based on the instance embedding, wherein the first machine learning model was trained using the set of training image samples; and
generating a set of similar image samples comprising the similar object instances from the set of training image samples.

7. The system of claim 6, the operations further comprising:
determining, using the first machine learning model, a respective confidence score for each of the similar object instances from the set of similar image samples;
determining, using the second machine learning model, a respective calibrated confidence score for each of the similar object instances from the set of similar image samples; and
responsive to determining that, for a first similar object instance, a difference between the respective confidence score and the respective calibrated confidence score exceeds a second threshold, generating an indication of a potential training data annotation error.

8. The system of claim 1, the operations further comprising:
generating, with the first machine learning model, a set of object instances from a first set of image samples, wherein for each object instance of the set of object instances, the first machine learning model computes a respective confidence score and a respective instance embedding;
computing, with the second machine learning model, a respective calibrated confidence score for each object instance of the set of object instances;
generating a second set of image samples based on one or more object instances from the first set of image samples for which a difference between the respective confidence score and the respective calibrated confidence score exceeds a threshold; and
clustering object instances from the second set of image samples based on the respective instance embedding for each of the one or more object instances.

9. A non-transitory computer-readable medium storing executable instructions, which when executed by a processing device, cause the processing device to perform operations comprising:
obtaining an image frame;
generating, with a first machine learning model, at least one object instance from the image frame;
computing for the at least one object instance, with the first machine learning model, a confidence score, a bounding box, and an instance embedding; and
computing, with a second machine learning model, a calibrated confidence score for the at least one object instance based on the instance embedding, the confidence score, and the bounding box.

10. The non-transitory computer-readable medium of claim 9, wherein the first machine learning model and the second machine learning model are executed via a neutral network.

11. The non-transitory computer-readable medium of claim 9, wherein the first machine learning model was trained to generate the at least one object instance based on a first training set comprising image frame samples; and
wherein the second machine learning model was trained separately from the first machine learning model using a second training set after training of the first machine learning model with the first training set is completed.

12. The non-transitory computer-readable medium of claim 11, wherein the second machine learning model was trained by:
computing a binary classification score for the bounding box, responsive to determining that the bounding box corresponds to an annotated ground truth bounding box; and
adjusting the second machine learning model based on a difference between the calibrated confidence score and the binary classification score.

13. The non-transitory computer-readable medium of claim 9, the operations further comprising:
detecting a potential training data annotation error by:
computing a difference between the confidence score and the calibrated confidence score;
responsive to determining that the difference exceeds a first threshold, searching a set of training image samples for similar object instances based on the instance embedding, wherein the first machine learning model was trained using the set of training image samples; and
generating a set of similar image samples comprising the similar object instances from the set of training image samples.

14. The non-transitory computer-readable medium of claim 13, wherein detecting the potential training data annotation error further comprises:
determining, using the first machine learning model, a respective confidence score for each of the similar object instances from the set of similar image samples;
determining, using the second machine learning model, a respective calibrated confidence score for each of the similar object instances from the set of similar image samples; and
generating an indication of the potential training data annotation error, responsive to determining that a difference between the respective confidence score and the respective calibrated confidence score exceeds a second threshold.

15. The non-transitory computer-readable medium of claim 9, the operations further comprising:
generating, with the first machine learning model, a set of object instances from a first set image samples, wherein for each object instance of the set of object instances the first machine learning model computes a respective confidence score;
computing, with the second machine learning model, a respective calibrated confidence score for each object instance of the of the set of object instances;
generating a second set of image samples based on one or more object instances from the first set image samples for which a difference between the respective confidence score and the respective calibrated confidence score exceeds a threshold; and
clustering object instances from the second set of image samples based on a respective instance embedding for each of the one or more object instances.

16. A method comprising:
receiving at a machine learning model, a training dataset comprising one or more object instances, each of the one or more object instances comprising an instance embedding, a confidence score, and a bounding box; and
training the machine learning model, using the training dataset, to compute a calibrated confidence score for each of the instance embedding, the confidence score, and the bounding box of the one or more object instances.

17. The method of claim 16, wherein training the machine learning model comprises:
computing a training correction using ground truth images used by another machine learning model to generate the instance embedding, the confidence score, and the bounding box for each of the one or more object instances.

18. The method of claim 16, further comprising:
generating, with another machine learning model, the one or more object instances of the training dataset from a first dataset.

19. The method of claim 18, wherein the machine learning model is trained separately from the another machine learning model after training of the another machine learning model is completed.

20. The method of claim 16, wherein training the machine learning model further comprises:
computing a binary classification score for the bounding box responsive to determining that the bounding box corresponds to an annotated ground truth bounding box; and
adjusting the machine learning model based on a difference between the calibrated confidence score and the binary classification score.
